(19) United States
(12) Patent Application Publication
(10) Pub. No.: US 2006/0034727 A1
(43) Pub. Date: Feb. 16, 2006

(54) Test plate and test method using the same

(75) Inventors: Shozo Takamura, Tokyo (JP); Tatsumaro Yamashita, Tokyo (JP); Yoshihisa Shibuya, Tokyo (JP)

Correspondence Address: BEYER WEAVER & THOMAS LLP, P.O. BOX 70250, OAKLAND, CA, 94612-0250, US

(73) Assignee: ALPS ELECTRIC CO., LTD.

(21) Appl. No.: 11/183,088

(22) Filed: Jul. 15, 2005

(30) Foreign Application Priority Data
Aug. 13, 2004 (JP) 2004-236054

(51) Int. Cl. G01N 31/22

(52) U.S. Cl. 422/58

(57) ABSTRACT

A test plate includes a plate substrate and a lid body. The plate substrate includes a flow path; an upstream storage chamber that is connected to the upstream side of the flow path and stores an upstream material; and a downstream storage chamber that is connected to the downstream side of the flow path and stores a downstream material. At least a portion of a surface of a space from the upstream storage chamber to the downstream storage chamber through the flow path is composed of a water-repellent surface.

### BACKGROUND OF THE INVENTION

1. Field of the Invention

The present invention relates to a simple test plate which can be used for a blood test, a urine test, or a DNA test by a medical institution or an individual, and more specifically, to a test plate in which an upstream material can be mixed with a downstream material stored in a downstream storage chamber at an arbitrary timing, and to a test method using the same.

2. Description of the Related Art

Recently, a test chip for a collected material from the human body, such as blood or urine, is increasingly developed. For example, a DNA chip where multiple kinds of DNA fragments (probes) are attached on a substrate, such as a glass substrate, can read the gene (test sample or target) collected from the human body at one time.

When a biochemical reaction, which has been conventionally performed by a test tube, a dropper, an agitator, and the like, is performed on the DNA chip, a test can be performed at high speed, and a test process can be simplified. Therefore, the method using the DNA chip has drawn attention.

In general, a test chip is mainly developed as a research chip for a university or a research institution at this time. However, it is expected in the future that a simple test chip for a medical institution or an individual will be commercialized.

Japanese Unexamined Patent Application Publication No. 2003-287479 discloses a valve mechanism suitable for an analyzer capable of simply performing an analysis or a detection of a micro sample.

Reference character V shown in FIG. 3 of Japanese Unexamined Patent Application Publication No. 2003-287479 represents a storage tank in which an absorbent polymer L is contained. Reference character S represents a liquid tank, and reference character W represents a drainage tank. The storage tank V, the liquid tank S, and the drainage tank W are connected to a branched capillary 12, respectively.

As shown in FIG. 4A of Japanese Unexamined Patent Application Publication No. 2003-287479, if a diaphragm film 14 of the liquid tank S is pressed, the liquid inside the liquid tank S flows in the capillary 12 in the direction of the arrow.

Next, as shown in FIG. 4B of Japanese Unexamined Patent Application Publication No. 2003-287479, if the diaphragm film 14 of the storage tank V is pressed, the absorbent polymer L inside the storage tank V is pushed out to block the capillary 12 through which the liquid tank S and the drainage tank W are connected to each other, so that the liquid is prevented from flowing from the liquid tank S to the drainage tank W.

In Japanese Unexamined Patent Application Publication No. 2003-287479, the liquid stored in the liquid tank S flows into the storage tank V and the drainage tank W, as shown in FIG. 4A. However, there is a case where the liquid stored in the liquid tank S is held therein for a predetermined time and the liquid is intended to flow into a predetermined tank from the capillary 12 at an arbitrary timing.

For example, a reagent, such as a probe, is previously stored in the liquid tank S, and a test sample is contained in another tank connected to the capillary 12. Then, at an arbitrary timing, the reagent is intended to flow into another tank in which the test sample is contained. However, in Japanese Unexamined Patent Application Publication No. 2003-287479, a test using such a method cannot be performed.

### SUMMARY OF THE INVENTION

The invention has been finalized in view of the drawbacks inherent in the related art, and an object of the invention is that it provides a test plate in which an upstream material stored in an upstream storage chamber flows into a downstream storage chamber storing a downstream material so that the upstream material and the downstream material can be mixed with each other in the downstream storage chamber at an arbitrary timing only when a test is intended to be performed, and a test method using the test plate.

According to an aspect of the present invention, a test plate includes a plate substrate and a lid body. The plate substrate includes a flow path; an upstream storage chamber that is connected to the upstream side of the flow path and stores an upstream material; and a downstream storage chamber that is connected to the downstream side of the flow path and stores a downstream material. At least a portion of a surface constituting a space from the upstream storage chamber to the downstream storage chamber through the flow path is composed of a water-repellent surface.

In this structure, the upstream material is repelled by the water-repellent surface so as not to reach the downstream storage chamber in which the downstream material is stored, but the upstream material can be blocked at least before the downstream storage chamber. For example, after the downstream material is stored in the downstream storage chamber, the upstream material is guided to the downstream storage chamber by using a predetermined means at an arbitrary timing when a test is intended to be performed, so that the upstream material and the downstream material can be mixed inside the downstream storage chamber.

In the above-mentioned structure, it is preferable that the water-repellent surface be formed on a portion of the surface constituting the space which is defined by the flow path or the upstream storage chamber. Accordingly, the upstream material can be properly blocked at least before the downstream storage chamber.

Further, in the above-mentioned structure, it is preferable that the water-repellent surface be formed on the entire surface constituting the space from the upstream storage chamber to the downstream storage chamber through the flow path. Accordingly, the test plate can be simply formed.

Furthermore, in the above-mentioned structure, it is preferable that the water-repellent surface be formed by coating the surface constituting the space with a water-repellent agent, or that the plate substrate and/or the lid body contain a water-repellent agent, so that the surface is composed of a water-repellent surface. Preferably, in the latter case, the test plate can be simply formed.

In addition, in the above-mentioned structure, it is preferable that the water-repellent agent contain a triazine-thiol-based or silicon-based coupling agent. Accordingly, the surface constituting the space can be properly coated with the water-repellent agent, or the water-repellent agent can be contained in the plate substrate or the lid body.

Moreover, in the above-mentioned structure, it is preferable that the upstream storage chamber be connected to a pressure transmission member, and that the downstream storage chamber be connected to a path for releasing the pressure from the pressure transmission member to the outside. Accordingly, the upstream material can be properly and simply sent to the downstream storage chamber.

In addition, it is preferable that the diameter of the path be smaller than the diameter of the flow path.

According to another aspect of the invention, there is provided a test method of performing a predetermined test using the above-mentioned test plate. The test method includes: previously storing the upstream material in the upstream storage chamber of the test plate so that at least the upstream material is repelled by the water-repellent surface and is maintained so as not to reach the downstream storage chamber; storing the downstream material in the downstream storage chamber; and sending the upstream material to the downstream storage chamber by using a predetermined means so that the upstream material and the downstream material are mixed with each other in the downstream storage chamber.

As described above, the upstream material is repelled by the water-repellent surface so as not to reach the downstream storage chamber in which the downstream material is stored, and the upstream material can be blocked at least before the downstream storage chamber. For this reason, after the downstream material is stored in the downstream storage chamber, the upstream material is guided to the downstream storage chamber by using a predetermined means at an arbitrary timing when a test is intended to be performed, so that the upstream material and the downstream material can be mixed with each other in the downstream storage chamber.

In the above-mentioned aspect, it is preferable that, after the downstream material is stored, the upstream material be sent to the downstream storage chamber by using the pressure transmission member. Accordingly, the upstream material is rapidly and simply sent into the downstream storage chamber, so that the upstream material and the downstream material can be mixed with each other in the downstream storage chamber.

In the above-mentioned aspect, it is preferable that the upstream material be a reagent, and that the downstream material be a test sample. For example, the upstream material is beads on which probes are fixed.

In this case, it is preferable that the diameter of the bead be larger than the diameter of the path connected to the downstream storage chamber, and that the bead be stemmed in the downstream storage chamber. Accordingly, the bead can be prevented from leaking to the outside through the path.

### BRIEF DESCRIPTION OF THE DRAWINGS

FIG. 1 is a partial perspective view illustrating the appearance of a test plate according to the invention;

FIG. 2 is a partial plan view when the test plate shown in FIG. 1 is seen from overhead;

FIG. 3 is a partial cross-sectional view in the case where the test plate is cut in the thickness direction along the line III-III of FIG. 2 so that the cross section thereof is seen from the arrow direction;

FIG. 4 is a diagram illustrating the flow direction of an upstream material at the time of test by using the same partial cross-sectional view as FIG. 2; and

FIG. 5 is a partial plan view illustrating a test plate according to another embodiment of the invention which is different from those of FIGS. 1 to 3.

### DESCRIPTION OF THE PREFERRED EMBODIMENT

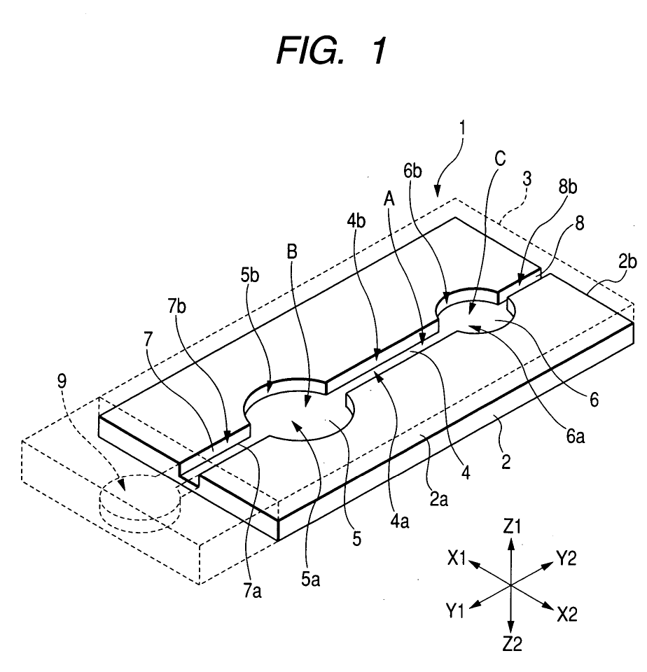

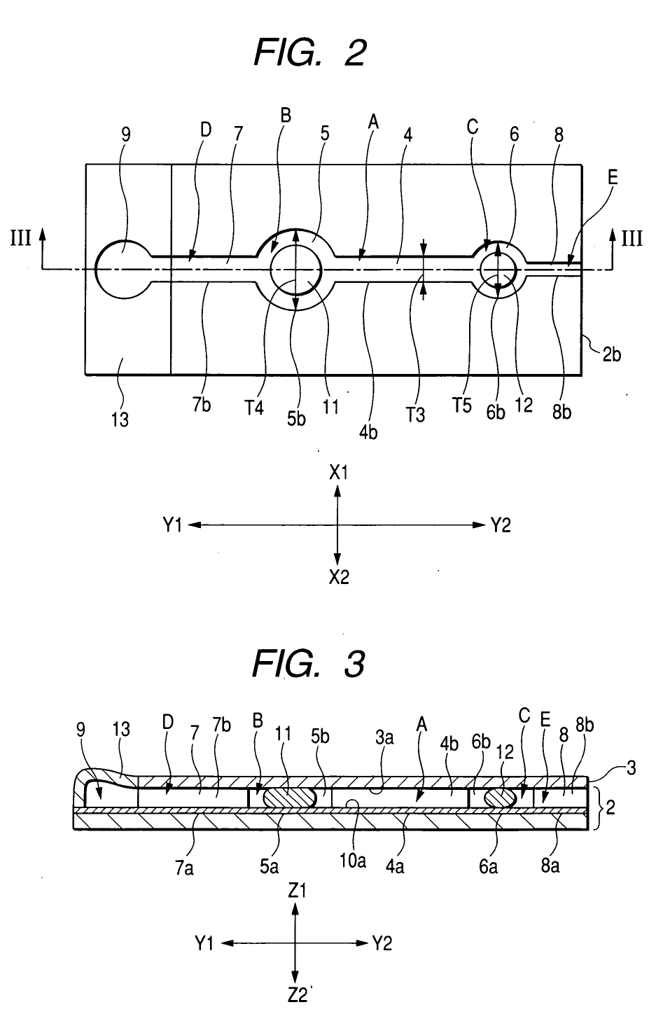

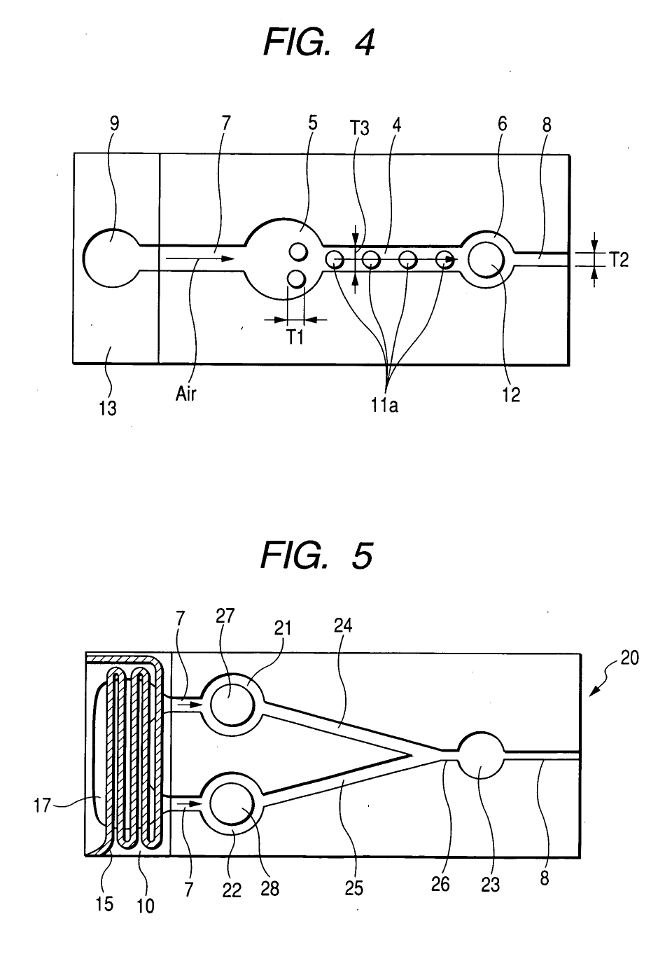

FIG. 1 is a partial perspective view illustrating the appearance of a test plate in the invention. FIG. 2 is a partial plan view when the test plate shown in FIG. 1 is seen from overhead. FIG. 3 is a partial cross-sectional view in the case where the test plate is cut in the thickness direction along the line III-III shown in FIG. 2 so that the cross section thereof is seen from an arrow direction. FIG. 4 is a diagram explaining the flow direction of an upstream material at the time of test by using the same partial cross-sectional view as FIG. 2. FIG. 5 is a partial plan view illustrating a test plate according to another embodiment of the invention which is different from those of FIGS. 1 to 3.

In FIG. 1, reference numeral 1 represents the test plate. The test plate 1 shown in FIG. 1 is a member in which blood or urine is collected from the human body and the collected material reacts with a predetermined reagent to perform a predetermined inspection. When the test plate is used as, for example, a DNA chip, the collected blood is subjected to a predetermined treatment to be used.

The test plate 1, which has a predetermined thickness to extend in the longitudinal direction (Y1-Y2 direction in FIG. 1) perpendicular to the width direction (X1-X2 direction in FIG. 2), has substantially a parallelepiped shape, but may have shapes other than the substantially parallelepiped shape.

The test plate 1 includes a plate substrate 2 and a lid body 3. The plate substrate 2 and the lid body 3 are formed of, for example, glass or resin. The plate substrate 2 and the lid body 3 are made of a material having predetermined fluorescence intensity. In particular, when the test plate 1 is used as, for example, a DNA chip or a protein chip, it is preferable that the test plate 1 be made of a material such as silica glass, polydimethylsiloxane (PDMS), or polymethyl methacrylate (PMMA) which exhibits low fluorescence and is excellent in chemical resistance.

When the test plate 1 is formed of resin, it is preferable that the test plate 1 be molded by injection molding. In some cases, hot pressing is performed, so that a groove, which is formed on a top surface 2a of the plate substrate 2 of the test plate 1, is molded to have a high aspect ratio. In addition, when the test plate 1 is formed of glass, it is molded by hot pressing.

The plate substrate 2 and the lid body 3 may not be formed of the same material. However, when the plate substrate 2 and the lid body 3 are formed of the same material, there is an advantage in that the plate substrate 2 and the lid body 3 are easily bonded to each other without an adhesive, for example.

On the top surface 2a of the plate substrate 2 shown in FIG. 1, there are formed a flow path 4, an upstream storage chamber 5 which is positioned upstream (Y1 side of FIG. 1) with respect to the flow direction of the material flowing in the flow path 4 and is connected to the flow path 4, and a downstream storage chamber 6 which is positioned downstream (Y2 side of FIG. 1) with respect to the flow direction of the material flowing in the flow path 4 and is connected to the flow path 4. The upstream storage chamber 5 and the downstream storage chamber 6 which are connected to the flow path 4 are formed in a groove shape.

As shown in FIG. 2, the flow path 4 is formed in a straight line to have a predetermined width T3. When the material flows in the flow path 4, turbulent flow hardly occurs, because the flow path 4 is formed in a straight line. However, the flow path 4 may be formed in shapes other than a straight line.

In addition, as shown in FIG. 2, both of the upstream storage chamber 5 and the downstream storage chamber 6 are formed substantially in circular shapes. However, they may have shapes other than the circular shape. As shown in FIG. 2, a maximum diameter T4 of the upstream storage chamber 5 and a maximum diameter T5 of the downstream storage chamber 6 are all larger than the width T3 of the flow path 4.

As shown in FIG. 2, the upstream storage chamber 5 and the downstream storage chamber 6 have substantially circular shapes, and side surfaces 5b and 6b of the upstream storage chamber 5 and the downstream storage chamber 6 are curved from a base portion where the side surfaces 5b and 6b are connected to a side surface 4b of the flow path 4, so that the turbulent flow of a material hardly occurs in the base portion. Therefore, the upstream storage chamber 5 and the downstream storage chamber 6 may have elliptic shapes or semicircular shapes where the curved surface faces the flow path 4, other than the substantially circular shape.

The flow path 4, the upstream storage chamber 5, and the downstream storage chamber 6 have bottom surfaces 4a, 5a, and 6a, and side surfaces 4b, 5b, and 6b which extend toward the top surface 2a from the bottom surfaces, respectively. The bottom surfaces and the side surfaces constitute the groove.

As shown in FIG. 3, the lid body 3 overlaps the plate substrate 2. Therefore, in a state where the lid body 3 is overlapped, the flow path 4, the upstream storage chamber 5, and the downstream storage chamber 6 constitute a space surrounded by the bottom surfaces 4a, 5a, and 6a, the side surfaces 4b, 5b, and 6b, and a lower surface 3a of the lid body 3. Hereinafter, a space A indicates a space constituting the flow path 4, a space B indicates a space constituting the upstream storage chamber 5, and a space C indicates a space constituting the downstream storage chamber 6.

In addition, a groove-shaped upstream path 7 connected to the upstream storage chamber 5 is formed at a side (Y1 side in FIGS. 1 to 3) of the upstream storage chamber 5 opposite to the flow path 4, as shown in FIGS. 1 to 3. In addition, a groove-shaped downstream path 8 connected to the downstream storage chamber 6 is formed at a side (Y2 side in FIGS. 1 to 3) of the downstream storage chamber 6 opposite to the flow path 4. These paths 7 and 8 also have bottom surfaces 7a and 8a and side surfaces 7b and 8b extending toward the top surface 2a from the bottom surfaces, respectively, thereby constituting a groove. Further, when the lid body 3 is overlapped, a space including the lower surface 3a of the lid body 3 is formed. Here, a space D indicates a space constituting the upstream path 7, and a space E indicates a space constituting the downstream path 8.

As shown in FIGS. 1 to 3, an end of the upstream path 7 opposite to the upstream storage chamber 5 is connected to a pressure transmission section 9. In addition, as shown in FIGS. 1 to 3, an end of the downstream path 8 opposite to the downstream storage chamber 6 is formed at the side surface 2b of the plate substrate 2, and the downstream path 8 is exposed (opened) outside from the side surface 2b of the plate substrate 2.

The invention is characterized in that at least a portion of the surface constituting the spaces A, B, and C from the upstream storage chamber 5 to the downstream storage chamber 6 through the flow path 4 is composed of a water-repellent surface.

As described above, ‘the surface constituting the spaces’ indicates any one of the groove-shaped bottom surfaces, the groove-shaped side surfaces, and the lower surface 3a of the lid body 3, which define the above-described spaces. The groove-shaped bottom surfaces and the groove-shaped side surfaces are formed in the plate substrate 2.

In the embodiment shown in FIG. 3, a coating layer 10 having excellent water repellency is provided on the bottom surface 4a of the flow path 4, the bottom surface 5a of the upstream storage chamber 5, and the bottom surface 6a of the downstream storage chamber 6. The coating layer 10 may not be formed or may be formed on the side surfaces 4b, 5b, and 6b constituting the respective spaces A, B, and C. A top surface 10a of the coating layer 10 functions as a water-repellent surface (hereinafter, there are some cases where the top surface 10a is referred to as a water-repellent surface).

In addition, the water-repellent surface 10a is preferably formed on a portion of the surface of the space A constituting the flow path 4 or on a portion of the surface of the space B constituting the upstream storage chamber 5. Therefore, the following structure also falls in the range of the invention. It is, for example, a structure where the coating layer 10 is formed only on the bottom surface 5a constituting the upstream storage chamber 5 or only on a portion of the bottom surface 5a, not on the entire bottom surface 5a, or a structure where the coating layer 10 is formed only on the bottom surface 4a (or a portion of the bottom surface 4a) of the flow path 4 shown in FIG. 3.

It is most preferable that the water-repellent surface 10a be formed on the entire surface of the spaces A, B, and C constituting the flow path 4, the upstream storage chamber 5, and the downstream storage chamber 6. In other words, it is most preferable that the coating layer 10 be formed on all of the bottom surfaces 4a, 5a, and 6a, the side surfaces 4b, 5b, and 6b of the plate substrate 2, and the lower surface 3a of the lid body 3, which constitute the spaces A, B, and C.

The coating layer 10 is made of a water-repellent material, such as resin or rubber, which includes fluorine or is formed of a hydrocarbon-based compound or silicon. Whether the surface 10a of the coating layer 10 is ‘a water-repellent surface’ or not is determined by measuring a contact angle. If the contact angle is large, the water-repellency is excellent. On the other hand, if the contact angle is small, the water-repellency is poor. By measuring the contact angle between the surface 10a where the coating layer 10 is formed and the surface of the plate substrate 2 where the coating layer 10 is not formed, it can be confirmed whether the surface 10a of the coating layer 10 is ‘a water-repellent surface’,

When the plate substrate 2 or the lid body 3 is formed of glass and the coating layer 10 is formed on a predetermined portion of the plate substrate 2 or the lid body 3, it is preferable that a coupling agent be added to the water-repellent agent constituting the coating layer 10 to increase the adhesive strength between the plate substrate 2 or the lid body 3 and the coating layer 10. As the coupling agent, a triazine-thiol-based or silane-based coupling agent is selected.

The coating layer 10 (water-repellent agent) can be formed by performing a printing method, a spin coating method, or a spray method on a predetermined portion of the plate substrate. However, in the case where the coating layer 10 is formed only on the bottom surface 5a of the upstream storage chamber 5, a mask needs to be put on the portion where the coating layer 10 is not formed, which makes the operation complicated. Therefore, it is preferable that the coating layer 10 be formed on the entire surface including the top surface 2a of the plate substrate 2 to improve operationality.

In the invention, when a fluorine-based water-repellent agent, for example, is contained in the plate substrate 2 and the lid body 3 so that the plate substrate 2 and the lid body 3 are all water-repellent, the entire surface constituting the spaces A, B, and C can also function as a water-repellent surface. In this case, a water-repellent treatment can be easily performed on the plate substrate 2 and the lid body 3, and thus operationality can be improved. In addition, the repellent agent contains a triazine-thiol-based or silane-based coupling agent. For example, a fluorine-based water-repellent agent is contained in the plate substrate 2, and thus the entire surface of the plate substrate 2 is treated to be water-repellent. Meanwhile, the lower surface 3a of the lid body 3 may be coated with the coating layer 10, and thus only the lower surface 3a may be treated to be water-repellent or vice versa.

As described above, at least a portion of the surface constituting the spaces A, B, and C is composed of a water-repellent surface. It is preferable that a portion of the surface of the space A or B which is defined by the flow path 4 or the upstream storage chamber 5 be formed of a water-repellent surface. It is most preferable that the entire surface constituting the spaces A, B, and C be formed of a water-repellent surface.

For this reason, in the invention, an upstream material 11 which is stored in the upstream storage chamber 5 can be prevented from reaching the downstream storage chamber 6 through the flow path 4 by a capillary action. The upstream material 11 is repelled by any one of ‘the water-repellent surfaces’, provided in the space from the upstream storage chamber 5 to the downstream storage chamber 6 through the flow path, so as not to be guided into the downstream storage chamber 6 until a certain means is used.

As shown in FIG. 2, the pressure transmission section 9 having a groove shape is formed in the side of the upstream path 7 of the plate substrate 2 opposite to the upstream storage chamber 5 to be connected to the upstream path 7. The pressure transmission section 9 is covered with a sheet 13 which is formed separately from the lid body 3. It is preferable that a concave section having the same shape as that of the pressure transmission section 9 be formed in the sheet 13. The sheet 13 is formed of a softer material than the plate substrate 2 and the lid body 3. Between the sheet 13 and the plate substrate 2, the parts, excluding the pressure transmission section 9, are bonded to each other, so that the pressure transmission section 9 defines a space. With the pressure transmission section 9 filled with air, the soft sheet 13 on the pressure transmission section 9 swells upward. A valve (not shown) is formed between the pressure transmission section 9 and the upstream path 7. Accordingly, before the upstream material 11 and a downstream material 12 are mixed with each other, air is not sent from the pressure transmission section 9 to the upstream path 7.

In addition, the lower side of the pressure transmission section 9 is also formed of a soft sheet which is formed separately from the plate substrate 2. Between the sheet of the plate substrate 2 and the sheet 13 of the lid body 3, the parts, excluding the pressure transmission section 9, are bonded to each other, so that a predetermined space of the pressure transmission section 9 which is connected to the upstream path 7 may be formed between the sheets.

In the invention, the upstream material 11 is first stored in the upstream storage chamber 5. For example, the upstream material 11 is a plurality of beads on which probes (DNA segments) are fixed. Since the bead is formed of, for example, glass or fiber, various kinds of fluorescent dyes are combined in different proportions in the bead.

As described above, at least a portion of the surface of the space A or B constituting the upstream storage chamber 5 or the flow path 4 is a water-repellent surface. Therefore, the upstream material 11 is repelled by any one of the water-repellent surfaces, provided in the space from the upstream storage chamber 5 to the downstream storage chamber 6 through the flow path, and is maintained so as not to be guided into the downstream storage chamber 6.

Next, the downstream material 12 is stored in the downstream storage chamber 6. The downstream material 12 is, for example, blood collected from the human body. In the case of DNA testing, the blood is subjected to a predetermined treatment, and the treated test sample is then stored in the downstream storage chamber 6.

Next, if an inspector holds the pressure transmission section 9 between the fingers to press the surface of the sheet 13 on the pressure transmission section 9 in the downward direction, the valve formed between the pressure transmission section 9 and the upstream path 7 is opened, so that the air filled in the pressure transmission section 9 is sent to the upstream path 7 (FIG. 4).

As shown in FIG. 4, the upstream material 11 stored in the upstream storage chamber 5 is sent into the downstream storage chamber 6 through the flow path 4 by the pressure of the air sent from the upstream path 7. As described above, the upstream materials 11 are multiple beads on which probes (DNA segments) are fixed. When the individual bead 11a reaches the downstream storage chamber 6 through the flow path 4, the downstream material (test sample) 12 stored in the downstream storage chamber 6 and the probes fixed on the beads 11a are mixed in the downstream storage chamber 6. Then, whether the probes fixed on the beads 11a and the downstream material (test sample) 12 react to each other or not (whether the probes and the test sample stick to each other or not) can be analyzed by measuring the fluorescence intensity of the beads 11a.

In FIG. 4, the flow path 4 is formed to have a diameter T3 larger than a diameter T2 of the downstream path 8. The bead 11a is formed to have an outer diameter of T1, which is smaller than the diameter T3, but is larger than the diameter T2. Accordingly, the beads 11a guided into the downstream chamber 6 are stemmed inside the downstream storage chamber 6. Further, the beads 11a can be prevented from draining outside through the downstream path 8.

The downstream path 8 functions as a path for releasing the air sent from the pressure transmission section 9. However, when at least one of the upstream material 11 and the downstream material 12 is liquid, the liquid easily drains outside through the downstream path 8. Therefore, in order to control the drain to the outside, it is preferable that the surface of the space E constituting the downstream path 8 be also a water-repellent surface.

If the surface of the space D constituting the upstream path 7 is also a water-repellent surface, the upstream material 11 can be prevented from being sent toward the pressure transmission section 9 through the upstream path 7.

In the above structure, although the pressure transmission section 9 is filled with air, it may be filled with, for example, the same material as the upstream material 11. In this case, the space D constituting the upstream path 7 does not have to be a water-repellent surface. By pressing the pressure transmission section 9, the upstream material 11 filled in the pressure transmission section 9 is sent to the upstream storage chamber 5 to be mixed with the upstream material 11 inside the upstream storage chamber 5. Further, the upstream material 11 is sent to the downstream storage chamber 6 by the pressure from the pressure transmission section 9 to be mixed with downstream material 12 in the downstream storage chamber 6.

In the above-described embodiment, the pressure transmission chamber 9 is provided at a side of the upstream storage chamber 5 opposite to the flow path 4. However, a pressure transmission means having the following structure may be used. A portion of the lid body 3 overlapping the upstream storage chamber 5 is formed of at least a soft material. By pressing the soft portion of the lid body 3 on the upstream storage chamber 5, the upstream material 11 stored in the upstream storage chamber 5 is sent to the downstream storage chamber 6. Moreover, the entire lid body 3 may be formed of a softer material than the plate substrate 2.

When the upstream material 11 is liquid, the entire surface of the spaces A to C is a water-repellent surface. Further, the liquid is maintained in a substantially spherical shape, and the spherical diameter is set to be larger than the diameter T3 of the flow path 4, so that the upstream material 11 can be held in the upstream storage chamber 5. In this case, if the spherical upstream material 11 is pushed into the flow path 4 by the air sent from the pressure transmission section 9 to the upstream storage chamber 5, the upstream material 11 is divided into small spheres whose diameters are smaller than the diameter T3 of the flow path 4 to move through the flow path 4. Then, these small spheres are mixed with the test sample of the downstream storage chamber 6 which is also maintained in a spherical shape, so that the test can be performed. At this time, since the mixed material in the downstream storage chamber 6 can be also maintained in a spherical shape, the mixed material does not drain outside through the downstream path 8.

FIG. 5 shows a test plate 20 having a structure different from those of FIGS. 1 to 4. In the test plate 20, two upstream storage chambers 21 and 22 are provided, and flow paths 24 and 25 are formed to extend to a downstream storage chamber 23 from the upstream storage chambers 21 and 22. The flow paths 24 and 25 form one flow path 26 in front of the downstream storage chamber 23, and the flow path 26 is connected to the downstream storage chamber 23. Moreover, in the embodiment shown in FIG. 5, the upstream path 8 is connected to the downstream storage chamber 23, and the upstream paths 7 are connected to the upstream storage chambers 21 and 22, respectively.

Also, in the embodiment shown in FIG. 5, at least a portion of the surface constituting the space from two upstream storage chambers 21 and 22 to the downstream storage chamber 23 through the flow paths 24, 25, and 26 is formed of a water-repellent surface. It is most preferable that the entire surface of the space constituting the upstream storage chambers 21 and 22, the flow paths 24, 25, and 26, and the downstream storage chamber 23 be composed of a water-repellent surface. A water-repellent treatment method is the same as described in the embodiment of FIGS. 1 to 4. Therefore, the method may be referred to.

In the embodiment of FIG. 5, upstream materials 27 and 28 are stored in the upstream storage chambers 21 and 22, respectively. The upstream materials 27 and 28 are repelled by the water-repellent surface formed on at least a portion of the surface of the space which is defined by the upstream storage chambers 21 and 22 and the flow paths 24, 25, and 26, and are held so as not to reach the downstream storage chamber 23.

After a downstream material (not shown) is stored in the downstream storage chamber 23, the upstream-materials 27 and 28 are guided to the downstream storage chamber 23 through the flow paths 24, 25, and 26 by the pressure from the pressure transmission section 16. Then, the upstream materials 27 and 28 and the downstream material are mixed inside the downstream storage chamber 23.

As shown in FIG. 5, a plurality of flow paths 24, 25, and 26 is formed, so that various test methods can be used. For example, a method having the following procedure is also considered. The upstream materials 27 and 28 are prepared as separate reagents to pass through the flow paths 24 and 25 in advance. After the upstream materials 27 and 28 are mixed (react) in a reaction room (not shown) provided near the upstream storage chambers 21 and 22 of the flow path 26 by which the flow paths are unified into one path, the mixed material is sent from the reaction room into the downstream storage chamber 23. In this case, the surface of the space constituting the flow paths 24 and 25 is subjected to a hydrophilic treatment, and the flow paths 24 and 25 may be formed so that the upstream materials 27 and 28 are guided to the reaction room by a capillary action. Meanwhile, the surface of the space constituting the flow path 26 is formed of a water-repellent surface. After the upstream materials 27 and 28 are properly mixed in the reaction room, the mixed material is guided into the downstream storage chamber 23 through the flow path 26 by the pressure from the pressure transmission section 16.

In addition, of the upstream storage chambers 21 and 22, the material 27 to be stored in the upstream storage chamber 21 is prepared as a reagent, and the material to be stored in the downstream storage chamber 23 is prepared as a test sample. Further, the material 28 to be stored in the upstream storage chamber 22 is prepared as a cleaning liquid. In this case, the pressure transmission section 16 which is connected to the upstream storage chambers 21 and 22 through the upstream paths 7 is separately provided. First, the upstream material (reagent) 27 stored in the upstream storage chamber 21 is guided into the downstream storage chamber 23 by the pressure from the pressure transmission section connected to the upstream storage chamber 21, and the test sample inside the downstream storage chamber 23 and the upstream material (reagent) 27 react to each other to perform a predetermined inspection. Then, the pressure transmission section connected to the upstream storage chamber 22 is pressed, so that the upstream material (cleaning liquid) 28 stored in the upstream storage chamber 22 is guided into the downstream storage chamber 23. The reactant of the reagent and the sample inside the downstream storage chamber 23 is drained outside through the downstream path 8 by the upstream material (cleaning liquid) 28. Since the downstream storage chamber 23 is cleaned by the cleaning liquid 28, the test sample is again stored in the downstream storage chamber 23 so that a predetermined test can be performed.

The test plate to be used as a medical application or personal use may be disposable and, as described above, the test plate can be used several times by using the cleaning liquid.

In the embodiment shown in FIGS. 1 to 4, the upstream material 11 stored in the upstream storage chamber 5 is guided to the downstream storage chamber 6 by the pressure generated from the pressure transmission section 9. However, the embodiment shown in FIG. 5 may have the following structure. A heater section (air expansion means) 15 is provided in the sheet 13 having the pressure transmission section 16, and the air inside the pressure transmission section 17 connected to the upstream paths 7 is expanded by the heat from the heater section 15 to be sent into the upstream storage chambers 21 and 22.

The invention is particularly useful for a plate having the following structure. After the downstream material 12 is stored in the downstream storage chamber 6, the upstream material 11 stored in the upstream storage chamber 5 is guided to the downstream storage chamber 6 only by a certain means (a specific means described in the invention is the pressure transmission means).

Therefore, in the invention, for example, beads on which probes (DNA fragments) are fixed or reagents for a blood test or a urine test are previously stored as the upstream materials 11, 27, and 28 in the upstream storage chamber 5, 21, and 22. A doctor or an individual can mix the upstream material 11 and the downstream material 12 in the downstream storage chamber 6 and 23 at an arbitrary timing when he or she wants to perform a test.

The test plate of the invention can be used as a DNA chip or a protein chip for convenient diagnosis. In addition, it can be used as a μ-TAS (micro-total analysis system) capable of performing reaction, separation, and analysis on one plate, a Lab-on-chip, a plate for micro factory, or the like.

As described above, according to the invention, the upstream material is repelled by the water-repellent surface so as not to reach the downstream storage chamber in which the downstream material is stored, and the upstream material can be blocked at least before the downstream storage chamber. For example, after the downstream material is stored in the downstream storage chamber, the upstream material is guided to the downstream storage chamber by using a predetermined means at an arbitrary timing when a test is desired to be performed, so that the upstream material and the downstream material can be mixed with each other in the downstream storage chamber.

1. A test plate comprising:
a plate substrate; and
a lid body,
wherein the plate substrate includes:
a flow path;
an upstream storage chamber that is connected to the upstream side of the flow path and stores an upstream material; and
a downstream storage chamber that is connected to the downstream side of the flow path and stores a downstream material, and
wherein at least a portion of a surface constituting a space from the upstream storage chamber to the downstream storage chamber through the flow path is composed of a water-repellent surface.

2. The test plate according to claim 1,
wherein the water-repellent surface is formed on the entire surface constituting the space from the upstream storage chamber to the downstream storage chamber through the flow path.

3. The test plate according to claim 1,
wherein the water-repellent surface is formed by coating the surface constituting the space with a water-repellent agent.

4. The test plate according to claim 1,
wherein the plate substrate and/or the lid body contains a water-repellent agent, so that the surface is composed of a water-repellent surface.

5. The test plate according to claim 1,
wherein the upstream storage chamber is connected to a pressure transmission member, and the downstream storage chamber is connected to a path for releasing the pressure from the pressure transmission member to the outside.

6. The test plate according to claim 5,
wherein the diameter of the path is smaller than the diameter of the flow path.

7. A test method using a test plate,
the test plate including:
a plate substrate; and
a lid body,
wherein the plate substrate includes:
a flow path;
an upstream storage chamber that is connected to the upstream side of the flow path and stores an upstream material; and
a downstream storage chamber that is connected to the downstream side of the flow path and stores a downstream material, and
wherein at least a portion of a surface constituting a space from the upstream storage chamber to the downstream storage chamber through the flow path is composed of a water-repellent surface,
the test method comprising:
previously storing the upstream material in the upstream storage chamber of the test plate so that at least the upstream material is repelled by the water-repellent surface and is maintained so as not to reach the downstream storage chamber;
storing the downstream material in the downstream storage chamber; and
sending the upstream material to the downstream storage chamber by using a predetermined-means so that the upstream material and the downstream material are mixed with each other in the downstream storage chamber.

8. The test method using a test plate according to claim 7,
wherein, after the downstream material is stored, the upstream material is then sent to the downstream storage chamber by using the pressure transmission member.

9. The test method using a test plate according to claim 7,
wherein the upstream material is a reagent, and the downstream material is a test sample.

10. The test method using a test plate according to claim 7,
wherein the upstream material is beads on which probes are fixed.

11. The test method using a test plate according to the claim 10,
wherein the diameter of the bead is larger than the diameter of the path connected to the downstream storage chamber, and the bead is stemmed inside the downstream storage chamber.
